(19) United States
(12) Patent Application Publication
(10) Pub. No.: US 2026/0125014 A1
(43) Pub. Date: May 7, 2026

(54) BATTERY PACK MODULE VIBRATION ISOLATION

(71) Applicant: Cummins Inc., Columbus, IN (US)

(72) Inventor: Kieran J. Richards, Northamptonshire (GB)

(21) Appl. No.: 18/935,148

(22) Filed: Nov. 1, 2024

(51) Int. Cl. B60R 16/04; B60K 1/04; B60K 6/28; H01M 50/242; H01M 50/249

(52) U.S. Cl. CPC B60R 16/04; H01M 50/242; H01M 50/249; B60K 1/04; B60K 6/28; H01M 2220/20

(57) ABSTRACT

The present disclosure provides a vibration damping mounting system to mount a batter pack module to a chassis of a vehicle including a top mount coupled to the battery pack module; a lower mount coupled to at least one of a mounting brace on a back panel of the battery pack module and an underside of the battery pack module; and a vibration damping element coupled to the lower mount. The vibration damping element may be at least one of a rubber damper, a spring, a torsion bar, and an air bag damper. The vibration damping element may be controlled by passive or active damping.

### FIELD

The present disclosure relates generally to a battery pack module vibration isolation system for mounting a battery pack module on a large equipment vehicle, such as a mining truck.

### BACKGROUND

Large equipment vehicles, such as haul trucks, mining vehicles, cranes, bulldozers, etc., may require a large power source to accommodate the workload and/or sheer size of the vehicle. The large equipment vehicles may be equipped with battery packs to increase peak power output during ascending, aid in breaking, recover energy when descending, and otherwise provide power to the engine. The large equipment vehicle may be subject to rough terrain, vibrations, steep inclines/declines, and other movement during operation that causes shocks and vibrations to be transferred to the chassis of the vehicle. These shocks and vibrations may damage battery pack modules coupled to the chassis of the vehicle if not managed and/or dampened.

### SUMMARY

The present disclosure provides a vibration damping mounting system configured to mount a battery pack module to a chassis of a vehicle, including: a top mount coupled to the battery pack module; a lower mount coupled to at least one of a mounting brace on a back panel of the battery pack module and an underside of the battery pack module; and a vibration damping element coupled to the lower mount. In another aspect of the vibration damping mounting system, the lower mount includes a lower chassis mount that extends from the chassis of the vehicle, and a lower battery pack mount that extends from at least one of the mounting brace on the back panel of the battery pack module and the underside of the battery pack module. Further, each of the lower chassis mount and the lower battery pack mount includes a pivot point configured to articulate such that a position of the battery pack module changes in relation to the vehicle chassis. In yet another aspect of the vibration damping mounting system, the top mount comprises a chassis mounting pin. In another aspect of the vibration damping mounting system, the vibration damping element is one of a damper and a torsion bar. In another aspect of the vibration damping mounting system, the vibration damping element includes a spring. In another aspect of the vibration damping mounting system, the vibration damping element includes a spring and a damper. In another aspect of the vibration damping mounting system, the vibration damping element is an air bag damper. Further, the air bag damper comprises a pneumatic valve, the pneumatic valve controls a damping rate of the air bag damper.

In a further aspect of the vibration damping mounting system, the vibration damping element is a passive damping element with a fixed damping rate. In another aspect of the vibration damping mounting system, the vibration damping element is a rubber damper. Further, the rubber damper is one of a disk, a pad, a bumper, a guard, and a block. In yet a further aspect, the rubber damper is filled with viscous material.

The present disclosure also provides a vibration damping mounting system configured to mount a battery pack module to a chassis of a vehicle, including: a top mount coupled to the battery pack module; a lower mount coupled to at least one of a mounting brace on a back panel of the battery pack module and an underside of the battery pack module; a vibration damping element coupled to the lower mount; and an accelerometer module. The accelerometer module includes: an accelerometer configured to determine forces of acceleration on the battery pack module about 6 degrees of freedom on an X, Y and Z axis; an actuator configured to increase or decrease a damping rate of the vibration damping element; and a control unit configured to receive signals from the accelerometer and transmit a command to the actuator. In another aspect of the accelerometer module, the accelerometer module further includes a GPS module configured to collect GPS data. Further, the GPS data includes at least one of: a change in elevation terrain, a sudden curve in a roadway, a speed of the vehicle, and a location of the vehicle. In yet another aspect of the damping mounting system, the control unit is further configured to receive the GPS data from the GPS and create a predictive map based on the GPS data. In another aspect of the vibration damping mounting system, the control unit is positioned on the vehicle. In one aspect of the vibration damping mounting system, the control unit is positioned remotely from the vehicle. Further, the accelerometer and the actuator are positioned on the vehicle.

The present disclosure further provides a method of controlling a vibration damping system of a battery pack module using live active damping, including: transmitting an accelerometer signal from an accelerometer to a control unit; processing the accelerometer signal from the accelerometer using the control unit to determine how much vibration damping is necessary to dampen the vibration of the battery pack module; transmitting a damping rate signal from the control unit to an actuator; and adjusting a damping rate of a vibration damping element by actuating the actuator such that the damping rate of the vibration damping element damps the vibration of the battery pack module. The accelerometer transmits a signal indicating vibration along 6 degrees of freedom on an X, Y, and Z axis. In one aspect further includes transmitting GPS data to a control unit; creating a predictive map of predicted vibration of the battery pack module based on the GPS data; locating the position of the battery pack module on the predictive map; and adjusting the damping rate of the vibration damping element using the actuator based on the position of the battery pack module on the predictive map such that vibration to the battery pack module is minimized. Further, GPS data includes information related to at least one of: a change in elevation, a terrain, a sudden curve in a roadway, and a speed of the vehicle. In yet another aspect of the method, adjusting the damping rate comprises the actuator adjusting a pneumonic valve of an air bag vibration damping element to increase or decrease a damping rate of the air bag vibration damping element. In another aspect of the method, adjusting a damping rate comprises the actuator adjusting at least one of spring compression, spring rate, torsion force, and damper shock absorbance to increase or decrease a damping rate of the vibration damping element.

### BRIEF DESCRIPTION OF THE DRAWINGS

The above-mentioned and other features and advantages of this disclosure, and the manner of obtaining them, will become more apparent, and will be better understood by reference to the following description of the exemplary embodiments taken in conjunction with the accompanying drawings, wherein:

FIG. 1 is a schematic top-down illustration of an architecture arrangement of components of a mining truck;

FIG. 2 illustrates a schematic top-down illustration of an architecture arrangement of components of a mining truck;

FIG. 3 illustrates a top-down schematic illustration of a battery pack module relative to a chassis and a plurality of wheels of a mining truck with the plurality of wheels in a first configuration;

FIG. 4 illustrates a top-down schematic illustration of the battery pack module of FIG. 3 with the plurality of wheels in a second configuration;

FIG. 5A is a perspective view of the battery pack module of the present disclosure;

FIG. 5B is a second perspective view of the battery pack module of FIG. 5A;

FIG. 5C is a third perspective view of the battery pack module of FIGS. 5A and 5B;

FIG. 6 is a perspective view of lifting supports of the battery pack module of the present disclosure;

FIG. 7 is an illustration of a first embodiment of the mounting system of the present disclosure including a passive rubber vibration damping element;

FIG. 8 is an illustration of a second embodiment of the mounting system of the present disclosure including a passive damper and spring vibration damping element;

FIG. 9 is an illustration of a third embodiment of the mounting system of the present disclosure including a passive air bag damper vibration damping element;

FIG. 10 is an illustration of a fourth embodiment of the mounting system of the present disclosure including an active damper and spring vibration damping element;

FIG. 11 is an illustration of a fifth embodiment of the mounting system of the present disclosure including an active air bag damping element; and

FIG. 12 is a method of active damping used by the embodiments in FIGS. 10 and 11.

### DETAILED DESCRIPTION

For the purposes of promoting an understanding of the principles of the present disclosure, reference is now made to the embodiments illustrated in the drawings, which are described below. The exemplary embodiments disclosed herein are not intended to be exhaustive or to limit the disclosure to the precise form disclosed in the following detailed description. Rather, these exemplary embodiments were chosen and described so that others skilled in the art may utilize their teachings.

The terms “couples”, “coupled”, “coupler”, and variations thereof are used to include both arrangements wherein the two or more components are in direct physical contact and arrangements wherein the two or more components are not in direct contact with each other (e.g., the components are “coupled” via at least a third component), but yet still cooperate or interact with each other.

In some instances throughout this disclosure and in the claims, numeric terminology, such as first, second, third, fourth, etc., is used in reference to various components of features. Such use is not intended to denote an ordering of the components or features. Rather, numeric terminology is used to assist the reader in identifying the components or features being referenced and should not be narrowly interpreted as providing a specific order of components or features.

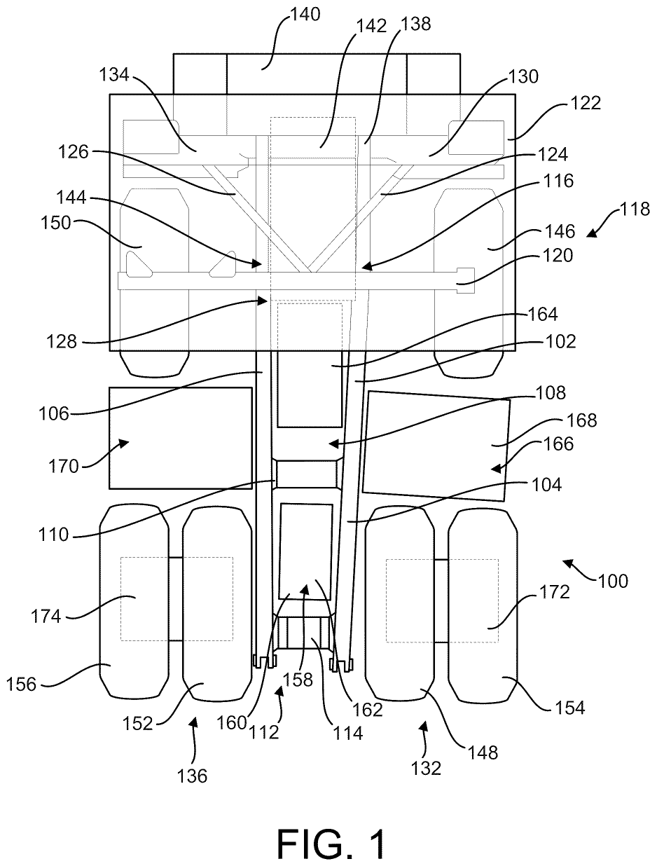

A schematic architecture of an exemplary mining truck 100 is illustrated in FIG. 1. As shown, mining truck 100 is generally built on and/or around chassis 102. chassis 102 includes a first frame member 104 and a second frame member 106 extending longitudinally to at least partially define a length of mining truck 100. First frame member 104 and second frame member 106 are spaced apart to form a space 108 therebetween, with a central crossbeam 110 extending from first frame member 104 to second frame member 106 across space 108, generally defining a rear chassis region 112. A rear crossbeam 114 extends from first frame member 104 to second frame member 106 across space 108 at the rear of chassis 102, and a horse collar 116 connects first frame member 104 and second frame member 106 within a forward region 118 of chassis 102.

A third frame member 120 extends across the top of horse collar 116 and beyond the diameter of horse collar 116 to form a support for a deck 122 as described further herein. A first supplemental frame member 124 and a second supplemental frame member 126 each extend diagonally from a central portion 128 of third frame member 120 above horse collar 116 in opposite directions so that first supplemental frame member 124 connects to a first support plate 130, first support plate 130 also connected to first frame member 104 on a first side 132 of chassis 102, and second supplemental frame member 126 connects to a second support plate 134, second support plate 134 also connected to second frame member 106 on a second side 136 of chassis 102. A forward crossbeam 138 extends from first frame member 104 to second frame member 106 in general alignment with first support plate 130 and second support plate 134. A support extension 140 extends forward of forward crossbeam 138. An engine 142 may be positioned within an opening 144 defined by horse collar 116. A traction alternator and/or gearbox may be mounted rearward of engine 142 within area 164.

Wheels 146, 148, 150, and 152 may be mounted to chassis 102 via respective axles (not shown). For example, as shown, first wheel 146 may be mounted at a forward position in forward region 118 on first side 132 of chassis 102. Second wheel 148 may be mounted at a rearward position in rear region 112 on first side 132 of chassis 102. Third wheel 150 may be mounted at a forward position in forward region 118 on second side 136 of chassis 102. Fourth wheel 152 may be mounted at a rearward position in rear region 112 on second side 136 of chassis 102. In some embodiments, mining truck 100 may include a fifth wheel 154 mounted adjacent to second wheel 148 at a rearward position in rear region 112 on first side 132 of chassis 102. Some embodiments may additionally include a sixth wheel 156 mounted adjacent to fourth wheel 152 at a rearward position in rear region 112 on second side 136 of chassis 102. First wheel 146 and third wheel 150 may be mounted at a position generally corresponding to third frame member 102. A rear region space 158 defined between first frame member 104 and second frame member 106 within rear chassis region 112, and at least partially defined between second wheel 148 and fourth wheel 152, may be sized and shaped to receive a vehicle subsystem 160.

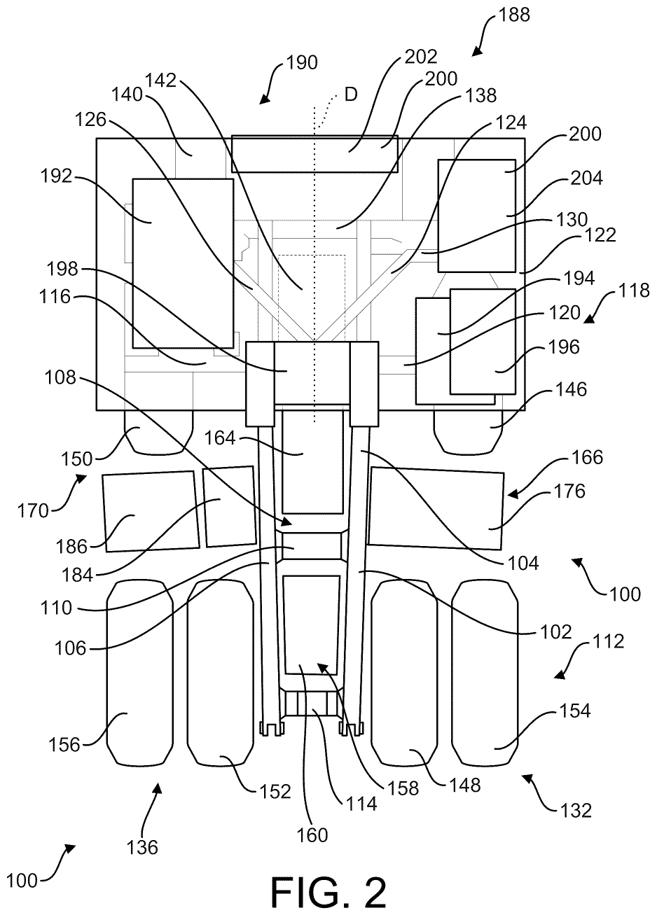

A position for a battery pack module 176 on a mining truck 100 is illustrated in FIG. 2. A mining truck 100, includes a chassis 102 having first frame member 104 and second frame member 106. First wheel 146 is mounted at a forward position in forward region 118 on first side 132 of chassis 102, i.e., adjacent to first frame member 104. Second wheel 148 is mounted at a rearward position in rear region 112 on first side 132 of chassis 102, i.e., adjacent to first frame member 104, and spaced apart from first wheel 146 to define first side saddle 166 therebetween. A battery pack module 176 may be mounted to first side 132 of chassis 102 within first side saddle 166.

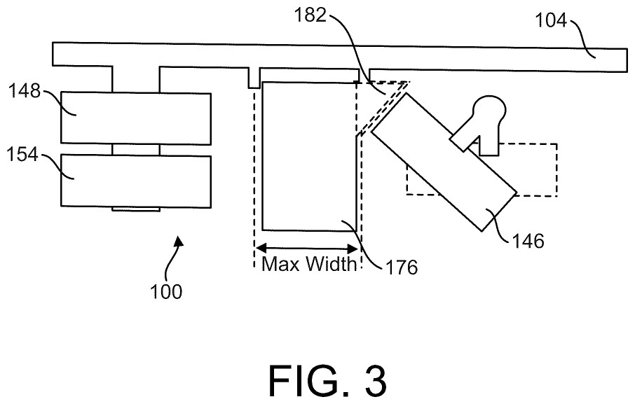

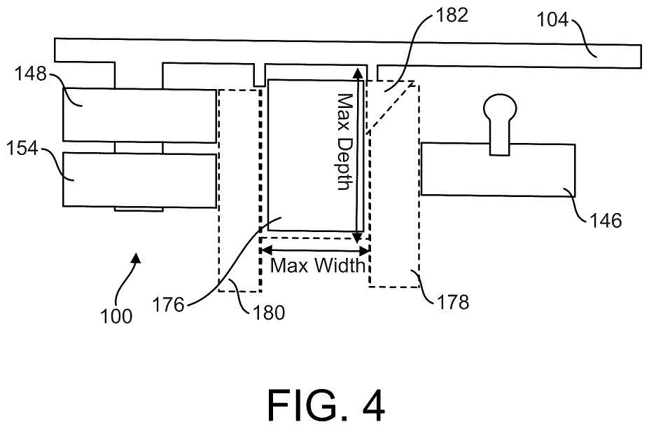

Battery pack module 176 is configured to store power for use in operation of mining truck 100. In hybrid applications, battery pack module 176 works in cooperation with engine 142 to provide power to wheels 146, 148, 150, 152 and, in some embodiments, wheels 154, 156 for movement of mining truck 100. Battery pack module 176 is mounted within first side saddle 166 at a position which mitigates potential contact of any one of wheels 146, 148, 150, 152, 154 (when present) and/or 156 (when present). As shown in FIGS. 3-4, for example, battery pack module 176 is mounted to chassis 102 in a manner that defines a forward access zone 178 defined between first wheel 146 and battery pack module 176 and a rearward access zone 180 defined between battery pack module 176 and second wheel 148. Forward access zone 178 and rearward access zone 180 provides clearance for movement of the wheels during operation of the mining truck, and also provides clearance for an operator, mechanic, or another person to stand within the appropriate access zone 178, 180 for access to battery pack module 176 for maintenance or other required or desired tasks. A steering zone 182 may be defined adjacent to a forward inner pocket to ensure additional clearance for the steering of first wheel 146 during operation of mining truck 100 as shown in FIG. 4.

Mounting of battery pack module 176 within first side saddle 166 may facilitate an even balance of mining truck 100 when one or more tanks are also mounted to chassis 102 within second side saddle 170 as discussed further herein. This placement may also maximize space for battery positioning while allowing the batteries to be put in a single, unified space rather than distributed in several places over the architecture of mining truck 100. While these benefits are acknowledged, it is also within the scope of this disclosure that battery pack module 176 and/or a plurality of battery packs may be alternately positioned, whether in a single, unified space (i.e., on deck 122, within rear region space 158, or another placement), or in a plurality of places throughout architecture of mining truck 100.

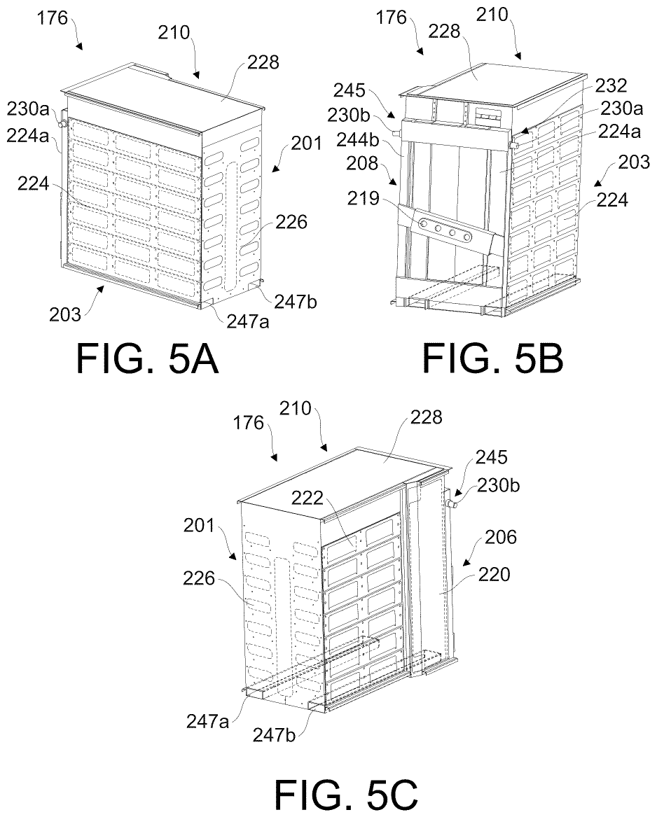

Referring to FIGS. 5A-5C, a battery pack module 176 of the present disclosure is illustrated. Battery pack module 176 includes a first side, or front panel 202; a second side, or back panel 208; a third side, or first sidewall panel 204 extending from front panel 202 to back panel 208; a fourth side, or second sidewall panel 206 extending from front panel 202 to back panel 208; and a fifth side, or top panel 210. Each panel of battery pack module 176 may have at least one service access, such as a door, portal, flap, etc., to allow access to the inside of the battery pack module 176 while the module is mounted to the truck 100 as described further herein.

Battery pack module 176 includes a mounting brace 219 coupled to back panel 208. Mounting brace 219 is configured to couple to a lower mount, as shown in FIG. 5B and discussed further below.

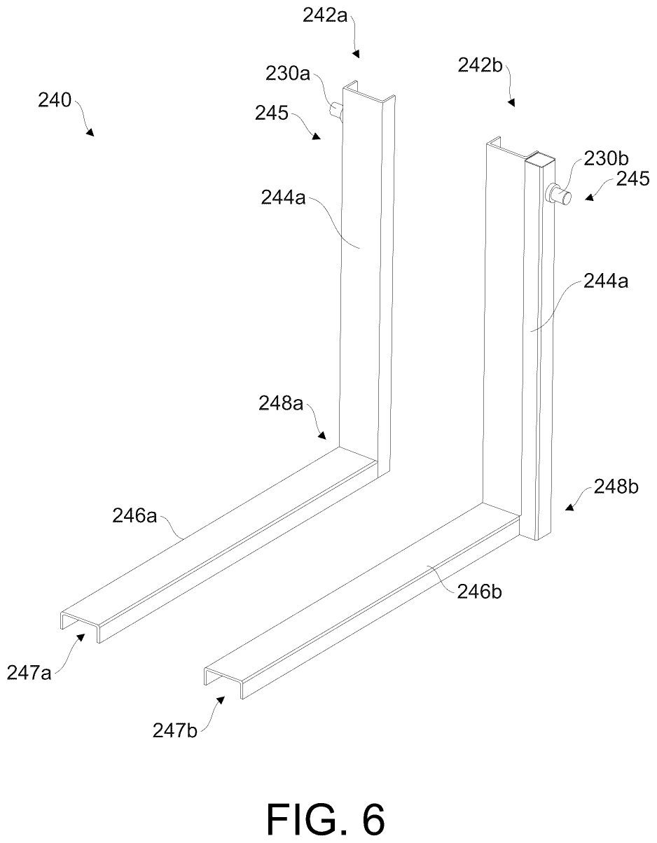

Battery pack module 176 may be mounted onto truck 100 in first side saddle 166 using a forklift or other lifting device. As shown in FIG. 6, lifting supports 240 may include a first support beam 242a and a second support beam 242b. In one embodiment, support beams 242a, 242b may be shaped to accommodate the forklift forks and spaced apart a distance that is the same as the distance the forklift forks are spaced apart. Support beams 242a, 242b each include a vertical portion 244a, 244b and a horizontal portion 246a, 246b. The horizontal portions 246a, 246b may each include an opening 247 configured to receive forklift forks or another lifting component of lifting equipment; in other words, openings 247 are sized and shaped to receive the forklift forks. Openings 247 may form pockets within horizontal portions 246a, 246b, and/or may be open toward the bottom of horizontal portions 246a, 246b to facilitate reception of forklift forks or other lifting tools. Support beams 242a, 242b may be spaced apart a distance which corresponds with forklift forks to facilitate reception of the forklift forks. Support beams 242a, 242b may be “L” shaped, or any other shape, such as a “C” shape, that suitably accommodates a lifting device to mount battery pack module 176 within side saddle 166 of truck 100. A distal end of vertical portion 244a may meet a distal end of horizontal portion 246a such that a coupling point 248a is formed. Similarly, a distal end of vertical portion 244b may meet a distal end of horizontal portion 246b such that a coupling point 248b is formed. In an alternative embodiment, lifting supports 240 may include only horizontal portions 246a, 246b of first and second support beams 242a, 242b.

### Mounting System

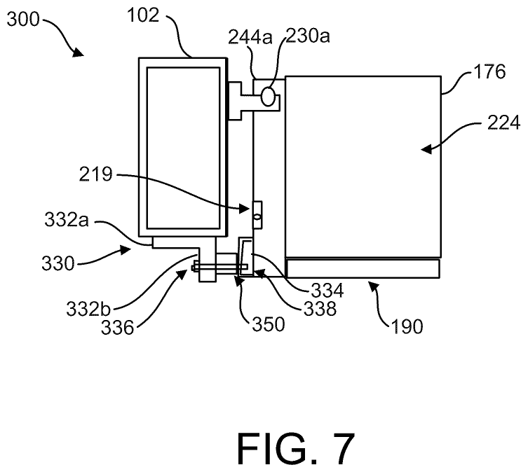

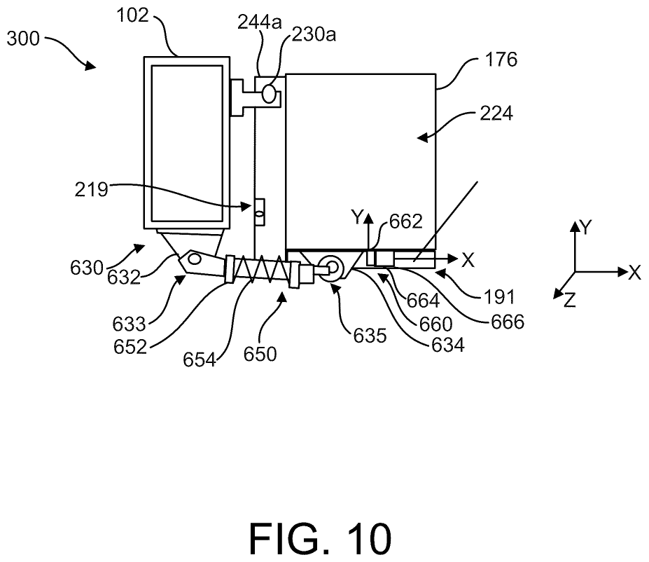

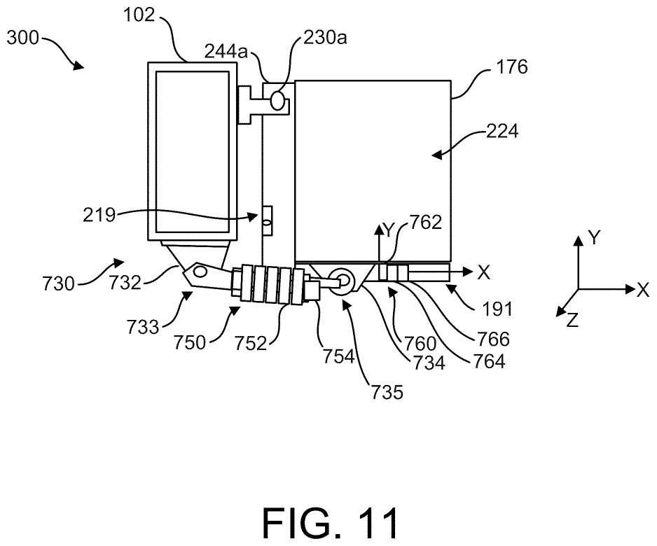

The battery pack module 176 may be removably coupled to mining truck 100 via a mounting system 300, FIGS. 7-11. Mounting system 300 may include at least one top mount 230, such as chassis mounting pins 230a, 230b (see also FIG. 6), a lower mount 330, 430, 530, 630, 730, and a vibration damping element 350, 450, 550, 650, 750. The embodiments of mounting system 300 may use either a passive damping element, such as the first, second, and third embodiments in FIGS. 7, 8, and 9, or an active damping element, such as the fourth and fifth embodiments in FIGS. 10 and 11. Each of the lower mounts 330, 430, 530, 630, 730 and each of the vibration damping elements 350, 450, 550, 650, 750 are described further herein.

### A. Top Mount

Referring briefly again to FIGS. 5A-6 in addition to FIGS. 7-11, the at least one top mount may be a mounting mechanism fixed on battery module 176, such as on back panel 208 (FIGS. 5A-5C) or on support beams 242a, 242b (FIG. 6), or a mounting mechanism fixed on chassis 102 of mining truck 100 (FIGS. 7-11). In the case that the at least one top mount is fixed on chassis 102 of mining truck 100, battery pack module 176 may include a top mount brace configured to removably couple to the at least one top mount.

Battery pack module 176 may include two top mounts to removably couple battery pack module 176 to chassis 102. Referring specifically to FIG. 6, each of the two top mounts may be a chassis mounting pin 230a, 230b fixed on a top portion/proximal end 245 of the vertical portion 244a, 244b of the first and second support beams 242a, 242b, respectively.

Each of chassis mounting pins 230a and 230b extends in a perpendicular direction away from the side 204, 206 of the battery pack module 176 and hooks into a pin receiving mount (not shown) on chassis 102 of truck 100. Alternatively, chassis mounting pins 230a, 230b may be coupled to a top portion of sheet metal side plates of the battery pack module 176 as discussed further in co-pending application entitled BATTERY PACK MODULE FOR HAUL TRUCK, filed the same day as the present application, and incorporated herein by reference.

### B. Lower Mount

Referring again to FIGS. 7-11, during operation of mining truck 100, such as driving over terrain, loading a truck bed, or use of the engine, vibrations and oscillations may be transferred through chassis 102 into the battery pack module 176. In some instances, these vibrations/oscillations may cause damage to battery pack module 176 and the components within the module. To mitigate damage, mounting system 300 includes a damping element 350, 450, 550, 650, 750 configured to reduce the vibrations passed from chassis 102 to module 176. Damping element 350, 450, 550, 650, 750 may be coupled to, or otherwise part of, a lower mount 330, 430, 530, 630, 730. By including damping element 350, 450, 550, 650, 750 in lower mount 330, 430, 530, 630, 730, vibrations may be reduced to each level of battery pack layers within battery pack module 176 instead of requiring multiple dampers 350 per layer.

A lower mount 330, 430, 530, 630, 730 may extend from chassis 102 of mining truck 100 and removably couple to batter pack module 176. Lower mount 330, 430, 530, 630, 730 may couple to an underside 190 of battery pack module 176. Alternatively, lower mount 330, 430, 530, 630, 730 may couple to a mounting brace 219 on back panel 208. Lower mount 330, 430, 530, 630, 730 may include a lower chassis mount or at least one lower pivot point; a vibration mitigation element such as a rubber disc, a spring, a torsion bar, and an air bag dampener; and an active damping component, such as at least one accelerometer and control unit. The lower mount may removably couple to mounting brace 219 such that vibration transferred from the mining truck into battery module 176 is reduced.

### C. Passive Damping Embodiments

Passive damping embodiments (FIGS. 7, 8, and 9) do not require external energy input to dissipate or damp vibrations or movements. The damping rate of passive damping mounting systems 300 of the present disclosure rely on the physical and inherent properties of the vibration damping elements 350, 450, 550, such as damping rate of the damping elements 350, 450, 550, to reduce transfer of vibrations to battery pack module 176.

A first embodiment of mounting system 300 is shown in FIG. 7. The first embodiment includes two top mounts (chassis pins 230a and 230b), one lower mount 330, and damping element 350. Lower mount 330 includes a lower chassis mount 332 that extends from chassis 102 of truck 100. Lower chassis mount 332 may include a horizontal portion 332a that is fixed along a surface of chassis 102 such that horizontal portion 332a runs parallel to the surface of chassis 102. At a first end of horizontal portion 332a, a vertical portion 332b extends perpendicular to chassis 102.

Battery pack lower mount 334 may extend from back panel 208 at mounting brace 219 or a bottom edge 338 of back panel 208. A coupling mechanism 336 extends between vertical portion 332b of lower chassis mount and battery pack lower mount 334. Coupling mechanism 336 is configured to removably couple vertical portion 332b of lower chassis mount and battery pack lower mount 334, mounting battery pack module 176 to chassis 102. Coupling mechanism 336 may be any suitable coupling such as mounting bolts, screws, and pins.

Between battery pack lower mount 334 and lower chassis mount 332 is a vibration damping element 350. Vibration damping element 350 may be a rubber damper such as a rubber disk, pad, bumper, guard, and block. In some embodiments, the vibration damping element 350 may be a rubber disk filled with a viscous material, such as a gel or other fluid. As truck is operated, vibrations and oscillations travel through chassis 102 into mounting system 300 and are damped by vibration damping element 350.

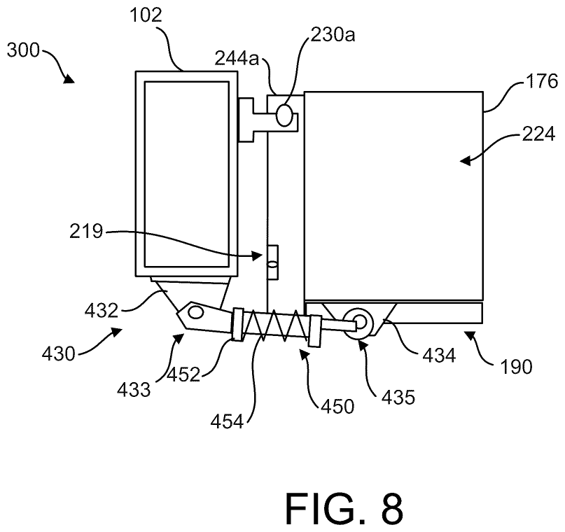

A second embodiment of mounting system 300 is shown in FIG. 8. The second embodiment includes two top mounts (chassis pins 230a and 230b (230b illustrated in FIG. 6)), one lower mount 430, and damping element 450. Lower mount 430 includes a lower chassis mount 432 including a first pivot point 433 and a battery pack lower mount 434 including a second pivot point 435. Lower chassis mount 432 may extend from a surface of chassis 102, similar to lower chassis mount 332 of the first embodiment in FIG. 7. Battery pack lower mount 434 may extend from back panel 208 at mounting brace 219 or underside 190 of battery pack module 176. First pivot point 433 and second pivot point 435 may allow the position of battery pack module 176 in relation to chassis 102 to be adjusted. Each pivot point 433, 435 may have an unlocked configuration in which the pivot points 433, 435 are configured to articulate in a pivoting motion up and down. The pivot points 433, 435 may have a locked configuration in which the pivot points 433, 435 are locked into position relative to chassis 102 and/or battery pack module 176 such that no articulation is possible while in the locked configuration. In some embodiments, one of pivot points 433, 435 may be in the unlocked configuration while the other of the pivot points 433, 435 is in the locked configuration. In other embodiments, both pivot points 433, 435 may be in the unlocked configuration or both pivot points 433, 435 may be in the locked configuration.

Between chassis lower mount 432 and battery pack lower mount 434 may be a vibration damping element 450. Vibration damping element 450 may be a damper 452, a spring isolator 454, or a combination thereof. Suitable dampers 452 may include a twin-tube damper, a monotube damper, a torsion bar, or any other suitable fixed damper. Spring isolator 454 may be a fixed spring or an adjustable spring. In embodiments that utilize both a damper 452 and a spring isolator 454, the spring isolator 454 may be fit over the damper 452 such that both damper 452 and spring isolator 454 are configured to absorb vibrations from operation of vehicle 100.

Vibration damping element 450 may have a fixed damping rate depending on the configuration of the damper and/or spring isolator. The damping rate of damper 452 and spring 454 may be manually adjusted via adjustment of the spring compression, spring rate, damper shock absorber, torsion force, and other mechanisms that affect damping rate of vibration damping element 450.

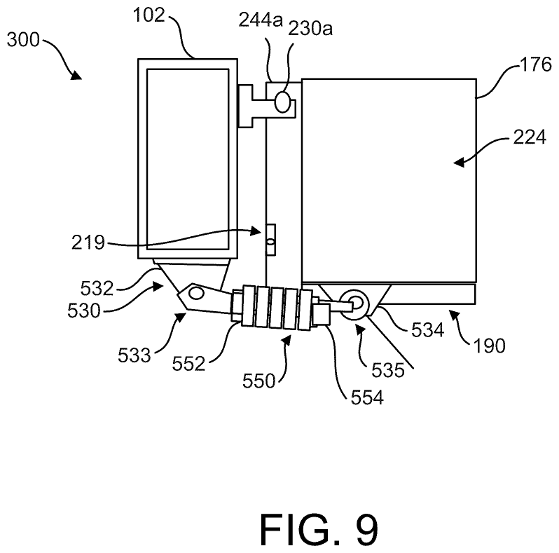

Referring to FIG. 9, in a third embodiment of mounting system 300, mounting system 300 includes two top mounts (chassis pins 230a and 230b (230b illustrated in FIG. 6)), one lower mount 530, and damping element 550. Lower mount 530 includes a lower chassis mount 532 may be substantially similar to the lower chassis mount 432 in the second embodiment, including a first pivot point 533 and a battery pack lower mount 534 including a second pivot point 535.

Between chassis lower mount 532 and battery pack lower mount 534 may be a vibration damping element 550. Vibration damping element 550 may be an air bag damper 552. Air bag damper 552 may include a chamber filled with air fluidly connected to a valve system, including a pneumatic control valve 554, that regulates the air pressure within the chamber. Vibrations transferred from chassis 102 to battery pack module 176 may be absorbed by air bag damper 552 as the air inside the chamber compresses to absorb the energy of the vibration or movement. The damping rate of air bag damper 552 may be manually adjusted by pneumatic control valve 554. Increasing the pressure within air bag damper 552 using pneumatic control valve 554 creates a stiffer damping rate of vibration damping element 550. Higher air pressure makes the air more resistant to compression, resulting in less vibration damping. Conversely, by releasing pneumatic control valve 554 and decreasing the pressure within air bag damper 552, the air within air bag damper 552 has more room to compress, creating a greater damping rate.

### D. Active Damping Embodiments

Active damping embodiments (FIGS. 10 and 11) actively control and adjust the damping forces in real-time to counteract vibrations, oscillations, or other unwanted movement that may be transferred to battery pack module 176.

As shown in FIG. 10, a fourth embodiment of mounting system 300 includes two top mounts (chassis pins 230a and 230b (230b illustrated in FIG. 6)), one lower mount 630, and damping element 650. Lower mount 630 may be substantially similar to lower mount 430.

Between chassis lower mount 632 and battery pack lower mount 634 may be a vibration damping element 650. Vibration damping element 650 may be a damper 652, a spring isolator 654, or a combination thereof, substantially similar to vibration damping element 450. However, vibration damping element 650 may have active damping facilitated by an accelerometer module 660. Accelerometer module 660 may include a control unit 662, at least one accelerometer 664, a GPS 666, and an actuator.

The at least one accelerometer 664 is a sensor that measures acceleration forces about 6 degrees of freedom on an X axis, Y axis, and Z axis. The at least one accelerometer 664 may be coupled to battery pack module 176, such as to underside of the battery pack module 190. In an alternative embodiment, the at least one accelerometer 664 may be coupled to truck chassis 102. In yet another embodiment, the at least one accelerometer 664 comprises a first accelerometer and a second accelerometer. The first accelerometer is coupled to battery pack module 176 and the second accelerometer is coupled to truck chassis 102.

The readings from the at least one accelerometer 664 are sent to control unit 662 and may be used to determine vibrations, oscillations, and other movement that battery pack module 176 may be experiencing and how the damping rate of vibration damping element 650 should be adjusted to absorb the vibrations. The actuator may be configured to increase or decrease the damping rate of damper 652, spring 654, or a combination of both in response to the readings received by control unit 662.

In embodiments comprising a first accelerometer coupled to battery pack module 176 and a second accelerometer coupled to truck chassis 102, control unit 662 may compare the accelerometer signals from each of the first and second accelerometers to determine vibrations, oscillations, and other movement that battery pack module 176 may be experiencing and how the damping rate of vibration damping element 650 should be adjusted to absorb the vibrations.

A GPS 666 may collect GPS data on a location. The GPS data may comprise information on elevation, terrain, sudden curves of roadways, and other elements that may contribute to the amount of vibration transferred from chassis 102 to battery pack module 176 during operation. GPS 666 may send the GPS data to control unit 662. Control unit 662 may process the data and create a predictive map of the location the data is taken from that includes predictions of vibrations battery pack module 176 may experience based on the GPS data. Control unit 662 may use the predictive map to determine predictive damping rates for vibration damping element 650 to minimize vibrations of battery pack module 176.

GPS 666 may further provide a current location of truck 100. Control unit 662 may receive the current location from GPS 666 and determine where on the predictive map truck 100 is located. For example, the predictive map may include a prediction that an increase in damping rate is necessary in a certain quadrant of the location the GPS data covers due to a paved roadway turning into a gravel roadway. The change in terrain from paved to gravel may cause an increase in vibration battery pack module 176 experiences, necessitating an increase in damping. When GPS 666 determines truck 100 is in the quadrant of the predictive map where the roadway turns to gravel, control unit 662 may send a signal to the actuator to increase the damping rate of vibration damping element 650.

In other embodiments, control unit 662 may use GPS data received from GPS 666 to identify the speed of truck 100. For example, control unit 662 may deduce the speed of truck 100 according to the speed at which truck 100 moves locations according to the GPS data. Control unit 662 may evaluate the vehicle speed in view of the current location of truck 100 and send a signal to the actuator to increase, decrease, or otherwise adjust the damping rate of vibration damping element 650 as needed in view of said vehicle speed and/or known change in the terrain surrounding vehicle 100 according to the location data provided by GPS 666.

Additionally or alternatively, the relative acceleration forces identifiable according to changes in the speed of truck 100 and/or change in location of truck 100 according to the GPS data provided by GPS may contribute to shock loading and vibration of battery pack module 176. Accordingly, control unit 662 may increase, decrease, or otherwise adjust the damping rate of vibration damping element 650 in view of such identified acceleration forces.

Accelerometer module 660 may be positioned anywhere on battery pack module 176 or lower mount 630 such that accelerometer module 660 may detect vibrations transferred to battery pack module 176. For example, accelerometer module 660 may be coupled to underside 190 of battery pack module 176. Alternatively, the components of the accelerometer module 660 may be coupled to different locations on the battery pack module 176 and truck chassis 102. For example, control unit 662 may be coupled to battery pack module 176 or truck chassis 102, the at least one accelerometer 664 may be coupled to battery pack module 176 or truck chassis 102, and GPS 666 may be coupled to battery pack module 176 or truck chassis 102. In other embodiments, components of accelerometer module 660 may be coupled to truck 100 at other various positions.

In some embodiments, control unit 662 may be a remote component. For example, control unit 662 may be located at a building, management site, or another location at a mining site local to but separate from truck 100. In other embodiments, control unit 662 may be located at a more remote mining site, control center, hardware manufacturer facility, or another facility remote from truck 100. In such embodiments, the other components of accelerator module 660 may communicate with control unit 662 via methods known in the art, such as telematics communication, 5G communication, or other communication methods which allow for communication over a particular distance, i.e., the distance between truck 100 and control unit 662.

In various embodiments, the data collected by the at least one accelerometer 664 and/or GPS 666 may be stored to a memory accessible by control unit 662.

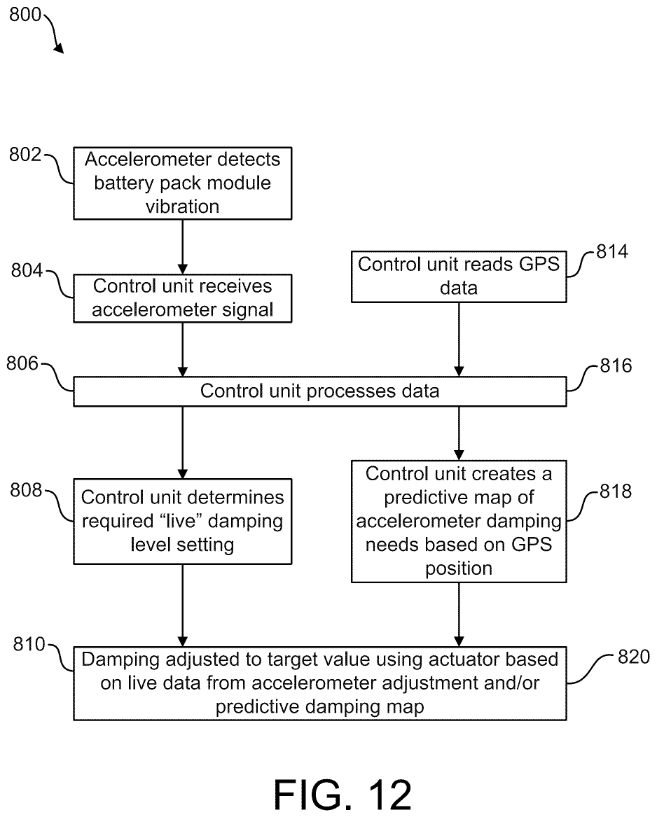

Accelerometer module 660 may use method 800 as shown in FIG. 12 to control vibration damping element 660 using active damping.

Referring to FIG. 11, a fourth embodiment of mounting system 300 includes two top mounts (chassis pins 230a and 230b (230b illustrated in FIG. 6)), one lower mount 730, and damping element 750. Lower mount 730 may be substantially similar to lower mount 530.

Between chassis lower mount 732 and battery pack lower mount 734 may be a vibration damping element 750. Vibration damping element 750 may be an air bag damper 752 substantially similar to air bag damper 550 of vibration damping element 550. However, vibration damping element 750 may have active damping facilitated by an accelerometer module 760. Accelerometer module 760 may include a control unit 762, at least one accelerometer 764, a GPS 766, and an actuator.

The at least one accelerometer 764 is a sensor that measures acceleration forces about 6 degrees of freedom on an X axis, Y axis, and Z axis. The at least one accelerometer 764 may be coupled to battery pack module 176, such as to underside of the battery pack module 190. In an alternative embodiment, the at least one accelerometer 764 may be coupled to truck chassis 102. In yet another embodiment, the at least one accelerometer 764 comprises a first accelerometer and a second accelerometer. The first accelerometer is coupled to battery pack module 176 and the second accelerometer is coupled to truck chassis 102.

The readings from the at least one accelerometer 764 are sent to control unit 762 and may be used to determine vibrations, oscillations, and other movement that battery pack module 176 may be experiencing and how the damping rate of vibration damping element 750 should be adjusted to absorb the vibrations. The actuator may be configured to increase or decrease the damping rate of damper 752, spring 754, or a combination of both in response to the readings received by control unit 762. In embodiments comprising a first accelerometer coupled to battery pack module 176 and a second accelerometer coupled to truck chassis 102, control unit 762 may compare the accelerometer signals from each of the first and second accelerometers to determine vibrations, oscillations, and other movement that battery pack module 176 may be experiencing and how the damping rate of vibration damping element 750 should be adjusted to absorb the vibrations.

A GPS 766 may collect GPS data on a location. The GPS data may comprise information on elevation, terrain, sudden curves of roadways, and other elements that may contribute to the amount of vibration transferred from chassis 102 to battery pack module 176 during operation. GPS 766 may send the GPS data to control unit 762. Control unit 762 may process the data and create a predictive map of the location the data is taken from that includes predictions of vibrations battery pack module 176 may experience based on the GPS data. Control unit 762 may use the predictive map to determine predictive damping rates for vibration damping element 750 to minimize vibrations of battery pack module 176.

GPS 766 may further provide a current location of truck 100. Control unit 762 may receive the current location from GPS 766 and determine where on the predictive map truck 100 is located. For example, in some circumstances, the predictive map may include a prediction that an increase in damping rate is necessary in a certain quadrant of the location the GPS data covers due to a paved roadway turning into a gravel roadway. The change in terrain from paved to gravel may cause an increase in the vibration that battery pack module 176 experiences, necessitating an increase in damping. When GPS 766 determines truck 100 is in the quadrant of the predictive map where the roadway turns to gravel, control unit 762 may send a signal to the actuator to increase the damping rate of vibration damping element 750.

In other embodiments, control unit 762 may use GPS data received from GPS 766 to identify the speed of truck 100. For example, control unit 762 may deduce the speed of truck 100 according to the speed at which truck 100 moves locations according to the GPS data. Control unit 762 may evaluate the vehicle speed in view of the current location of truck 100 and send a signal to the actuator to increase, decrease, or otherwise adjust the damping rate of vibration damping element 750 as needed in view of said vehicle speed and/or known change in the terrain surrounding vehicle 100 according to the location data provided by GPS 766.

Additionally or alternatively, the relative acceleration forces identifiable according to changes in the speed of truck 100 and/or change in location of truck 100 according to the GPS data provided by GPS may contribute to shock loading and vibration of battery pack module 176. Accordingly, control unit 762 may increase, decrease, or otherwise adjust the damping rate of vibration damping element 750 in view of such identified acceleration forces.

Accelerometer module 760 may be positioned anywhere on battery pack module 176 or lower mount 730 such that accelerometer module 760 may detect vibrations transferred to battery pack module 176. For example, accelerometer module 760 may be coupled to underside 190 of battery pack module 176. Alternatively, the components of the accelerometer module 760 may be coupled to different locations on the battery pack module 176 and truck chassis 102. For example, control unit 762 may be coupled to battery pack module 176 or truck chassis 102, the at least one accelerometer 764 may be coupled to battery pack module 176 or truck chassis 102, and GPS 766 may be coupled to battery pack module 176 or truck chassis 102. In other embodiments components of accelerometer module 760 may be coupled to truck 100 at other various positions.

In some embodiments, control unit 762 may be a remote component. For example, control unit 762 may be located at a building, management site, or another location at a mining site local to but separate from truck 100. In other embodiments, control unit 762 may be located at a more remote mining site, control center, hardware manufacturer facility, or another facility remote from truck 100. In such embodiments, the other components of accelerator module 760 may communicate with control unit 762 via methods known in the art, such as telematics communication, 5G communication, or other communication methods which allow for communication over a particular distance, i.e., the distance between truck 100 and control unit 762.

In various embodiments, the data collected by the at least one accelerometer 764 and/or GPS 766 may be stored to a memory accessible by control unit 762.

Accelerometer module 760 may use method 800 as shown in FIG. 12 to control vibration damping element 760 using active damping.

Method 800 of FIG. 12 includes two ways to perform active damping using an accelerometer module, live active damping, and predictive active damping.

During live active damping, in a first step 802, the accelerometer may detect battery pack module vibration. The accelerometer may send the control unit a signal of the detected vibration, step 804. In step 806, the control unit processes the signal. The processed signal is used to determine the required level of damping needed to reduce the vibration. In step 808, the control unit determines the settings the vibration damping element of mounting system 300 needed to reduce the vibration. This may include increasing or decreasing air pressure, spring tension, spring compression, spring rate, torsion force, or any other mechanism the vibration damping element uses to absorb vibrations. Finally, in step 810, control unit sends a signal to an actuator to adjust the damping rate of the vibration damping element to the determined setting. By reacting to vibrations live, method 800 provides mounting system 300 the ability to react to changes in the level of vibration damping required to avoid damage to battery pack module 176.

During predictive active damping, in a first step 814, the control unit reads GPS data of a desired area in which mining truck 100 may be used. The GPS data collected by the control unit may relate to changes in elevation, terrain, sudden curves of roadways, and other elements that may contribute to the amount of vibration transferred from chassis 102 to battery pack module 176 during operation. The control unit may then process the data, step 816. The processed data, in step 818, may then be used to create a predictive map of the desired area that includes necessary damping rates to accommodate for the elements of the area that may cause vibrations of battery pack module 176. For example, the predictive map may include a prediction that an increase in damping rate is necessary in a certain quadrant of the desired area due to a paved roadway turning into a gravel roadway. Finally, in step 820, during operation of mining truck 100, the control module uses the GPS to determine where mining truck 100 is positioned on the predictive map and signals the actuator to adjust the damping rate of the vibration damping element based on the previously made prediction in step 818. By using the predictive active damping, mounting system 300 may be prepared to adjust the damping rate of vibration damping elements preemptively based on the predictive map created by the control module.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practices in the art to which this disclosure pertains.

### Aspects

Aspect 1 is a vibration damping mounting system configured to mount a battery pack module to a chassis of a vehicle, comprising: a top mount coupled to the battery pack module; a lower mount coupled to at least one of a mounting brace on a back panel of the battery pack module and an underside of the battery pack module; and a vibration damping element coupled to the lower mount.

Aspect 2 is the vibration damping mounting system of Aspect 1, wherein the lower mount comprises a lower chassis mount that extends from the chassis of the vehicle, and a lower battery pack mount that extends from at least one of the mounting brace on the back panel of the battery pack module and the underside of the battery pack module.

Aspect 3 is the vibration damping mounting system of Aspect 2, wherein each of the lower chassis mount and the lower battery pack mount comprise a pivot point configured to articulate such that a position of the battery pack module changes in relation to the vehicle chassis.

Aspect 4 is the vibration damping mounting system of any one of Aspects 1-3, wherein the top mount comprises a chassis mounting pin.

Aspect 5 is the vibration damping mounting system of any one of Aspects 1-4, wherein the vibration damping element is one of a damper and a torsion bar.

Aspect 6 is the vibration damping mounting system of any one of Aspects 1-4, wherein the vibration damping element includes a spring.

Aspect 7 is the vibration damping mounting system of Aspect 6, wherein the vibration damping element includes a spring and a damper.

Aspect 8 is the vibration damping mounting system of any one of Aspects 1-4, wherein the vibration damping element is an air bag damper.

Aspect 9 is the vibration damping mounting system of Aspect 8, wherein the air bag damper comprises a pneumatic valve, the pneumatic valve controls a damping rate of the air bag damper.

Aspect 10 is the vibration damping mounting system of any one of Aspects 1-9, wherein the vibration damping element is a passive damping element with a fixed damping rate.

Aspect 11 is the vibration damping mounting system of any one of Aspects 1-4, wherein the vibration damping element is a rubber damper.

Aspect 12 is the vibration damping mounting system of Aspect 11, wherein the rubber damper is one of a disk, a pad, a bumper, a guard, and a block.

Aspect 13 is the vibration damping mounting system of either Aspect 11 or Aspect 12, wherein the rubber damper is filled with viscous material.

Aspect 14 is a vibration damping mounting system configured to mount a battery pack module to a chassis of a vehicle, comprising: a top mount coupled to the battery pack module; a lower mount coupled to at least one of a mounting brace on a back panel of the battery pack module and an underside of the battery pack module; a vibration damping element coupled to the lower mount; an accelerometer module, the accelerometer module comprising: an accelerometer configured to determine forces of acceleration on the battery pack module about 6 degrees of freedom on an X, Y and Z axis; an actuator configured to increase or decrease a damping rate of the vibration damping element; and a control unit configured to receive signals from the accelerometer and transmit a command to the actuator.

Aspect 15 is the vibration damping mounting system of Aspect 14, wherein the accelerometer module further comprising a GPS module configured to collect GPS data.

Aspect 16 is the vibration damping mounting system of Aspect 15, wherein the GPS data comprises at least one of: a change in elevation terrain, a sudden curve in a roadway, a speed of the vehicle, and a location of the vehicle.

Aspect 17 is the vibration damping mounting system of either Aspect 15 or Aspect 16, wherein the control unit is further configured to receive the GPS data from the GPS and create a predictive map based on the GPS data.

Aspect 18 is the vibration damping mounting system of any of Aspects 14-17, wherein the control unit is positioned on the vehicle.

Aspect 19 is the vibration damping mounting system of any of Aspects 14-17, wherein the control unit is positioned remotely from the vehicle.

Aspect 20 is the vibration damping mounting system of Aspect 19, wherein the accelerometer and the actuator are positioned on the vehicle.

Aspect 21 is a method of controlling a vibration damping system of a battery pack module using live active damping, comprising: transmitting an accelerometer signal from an accelerometer to a control unit; wherein the accelerometer transmits a signal indicating vibration along 6 degrees of freedom on an X, Y, and Z axis; processing the accelerometer signal from the accelerometer using the control unit to determine how much vibration damping is necessary to dampen the vibration of the battery pack module; and transmitting a damping rate signal from the control unit to an actuator; and adjusting a damping rate of a vibration damping element by actuating the actuator such that the damping rate of the vibration damping element damps the vibration of the battery pack module.

Aspect 22 is the method of Aspect 21, further comprising: transmitting GPS data to a control unit; creating a predictive map of predicted vibration of the battery pack module based on the GPS data; locating the position of the battery pack module on the predictive map; and adjusting the damping rate of the vibration damping element using the actuator based on the position of the battery pack module on the predictive map such that vibration to the battery pack module is minimized.

Aspect 23 is the method of Aspect 22, wherein GPS data comprises information related to at least one of: a change in elevation, a terrain, a sudden curve in a roadway, and a speed of the vehicle.

Aspect 24 is the method of any one of Aspects 21-23, wherein adjusting the damping rate comprises the actuator adjusting a pneumonic valve of an air bag vibration damping element to increase or decrease a damping rate of the air bag vibration damping element.

Aspect 25 is the method of any one of Aspects 21-24, wherein adjusting a damping rate comprises the actuator adjusting at least one of spring compression, spring rate, torsion force, and damper shock absorbance to increase or decrease a damping rate of the vibration damping element.

What is claimed is:

1. A vibration damping mounting system configured to mount a battery pack module to a chassis of a vehicle, comprising:
a top mount coupled to the battery pack module;
a lower mount coupled to at least one of a mounting brace on a back panel of the battery pack module and an underside of the battery pack module; and
a vibration damping element coupled to the lower mount.

2. The vibration damping mounting system of claim 1, wherein the lower mount comprises a lower chassis mount that extends from the chassis of the vehicle, and a lower battery pack mount that extends from at least one of the mounting brace on the back panel of the battery pack module and the underside of the battery pack module.

3. The vibration damping mounting system of claim 2, wherein each of the lower chassis mount and the lower battery pack mount comprise a pivot point configured to articulate such that a position of the battery pack module changes in relation to the vehicle chassis.

4. The vibration damping mounting system of claim 1, wherein the top mount comprises a chassis mounting pin.

5. The vibration damping mounting system of claim 1, wherein the vibration damping element is one of a damper and a torsion bar.

6. The vibration damping mounting system of claim 1, wherein the vibration damping element includes a spring.

7. The vibration damping mounting system of claim 6, wherein the vibration damping element includes a spring and a damper.

8. The vibration damping mounting system of claim 1, wherein the vibration damping element is an air bag damper.

9. The vibration damping mounting system of claim 8, wherein the air bag damper comprises a pneumatic valve, the pneumatic valve controls a damping rate of the air bag damper.

10. The vibration damping mounting system of claim 1, wherein the vibration damping element is a passive damping element with a fixed damping rate.

11. The vibration damping mounting system of claim 1, wherein the vibration damping element is a rubber damper.

12. The vibration damping mounting system of claim 11, wherein the rubber damper is one of a disk, a pad, a bumper, a guard, and a block.

13. The vibration damping mounting system of claim 11, wherein the rubber damper is filled with viscous material.

14. A vibration damping mounting system configured to mount a battery pack module to a chassis of a vehicle, comprising:
a top mount coupled to the battery pack module;
a lower mount coupled to at least one of a mounting brace on a back panel of the battery pack module and an underside of the battery pack module;
a vibration damping element coupled to the lower mount; and
an accelerometer module, the accelerometer module comprising:
an accelerometer configured to determine forces of acceleration on the battery pack module about 6 degrees of freedom on an X, Y and Z axis;
an actuator configured to increase or decrease a damping rate of the vibration damping element; and
a control unit configured to receive signals from the accelerometer and transmit a command to the actuator.

15. The vibration damping mounting system of claim 14, wherein the accelerometer module further comprising a GPS module configured to collect GPS data.

16. The vibration damping mounting system of claim 15, wherein the GPS data comprises at least one of: a change in elevation terrain, a sudden curve in a roadway, a speed of the vehicle, and a location of the vehicle.

17. The vibration damping mounting system of either claim 15, wherein the control unit is further configured to receive the GPS data from the GPS and create a predictive map based on the GPS data.

18. The vibration damping mounting system of claim 14, wherein the control unit is positioned on the vehicle.

19. The vibration damping mounting system of claim 14, wherein the control unit is positioned remotely from the vehicle.

20. The vibration damping mounting system of claim 19, wherein the accelerometer and the actuator are positioned on the vehicle.

21. A method of controlling a vibration damping system of a battery pack module using live active damping, comprising:
transmitting an accelerometer signal from an accelerometer to a control unit;
wherein the accelerometer transmits a signal indicating vibration along 6 degrees of freedom on an X, Y, and Z axis;
processing the accelerometer signal from the accelerometer using the control unit to determine how much vibration damping is necessary to dampen the vibration of the battery pack module;
transmitting a damping rate signal from the control unit to an actuator; and
adjusting a damping rate of a vibration damping element by actuating the actuator such that the damping rate of the vibration damping element damps the vibration of the battery pack module.

22. The method of claim 21, further comprising:
transmitting GPS data to a control unit;
creating a predictive map of predicted vibration of the battery pack module based on the GPS data;
locating the position of the battery pack module on the predictive map; and
adjusting the damping rate of the vibration damping element using the actuator based on the position of the battery pack module on the predictive map such that vibration to the battery pack module is minimized.

23. The method of claim 22, wherein GPS data comprises information related to at least one of: a change in elevation, a terrain, a sudden curve in a roadway, and a speed of the vehicle.

24. The method of claim 21, wherein adjusting the damping rate comprises the actuator adjusting a pneumonic valve of an air bag vibration damping element to increase or decrease a damping rate of the air bag vibration damping element.

25. The method of claim 21, wherein adjusting a damping rate comprises the actuator adjusting at least one of spring compression, spring rate, torsion force, and damper shock absorbance to increase or decrease a damping rate of the vibration damping element.
